(19) United States
(12) Patent Application Publication
(10) Pub. No.: US 2011/0013374 A1
(43) Pub. Date: Jan. 20, 2011

(54) Integral Spring Clip for Heat Dissipators

(76) Inventor: Kechuan Kevin Liu, Weston, FL (US)

Correspondence Address: Mr. Kevin Liu;Design Realization, Inc., 197 Alhambra Way, Weston, FL, 33326, US

(21) Appl. No.: 12/460,262

(22) Filed: Jul. 16, 2009

(51) Int. Cl. H02B 1/01

(52) U.S. Cl. 361/825

(57) ABSTRACT

An integral spring clip for use with a heat dissipator or heat sink apparatus comprises a securing portion and an attaching portion. The securing portion is configured to flex about a pivot axis to effect an engaged relation to substantially fixedly maintain the electronic component in abutting relation to the heat absorbing surface of a heat dissipater or a heat sink apparatus and secure it in a predefined position. The attaching portion comprises a plurality of solderable elements and is configured to attach a heat dissipator assembly in either vertical or horizontal orientation firmly onto a printed circuit or wiring board in a pre-defined place via soldering techniques. The ramified integral spring clip with a cam bar added on will further facilitate the assembly and disassembly operations. The integral spring clip is a simple unitary design and made of a single length spring wire with whole or selective solder coating.

### CROSS-REFERENCE TO RELATED APPLICATIONS

None

### STATEMENT REGARDING FEDERAL SPONSORED RESEARCH OR DEVELOPMENT

Not Applicable

### FIELD OF THE INVENTION

This invention generally relates to the art of spring clip and, particularly, to an integral spring clip engaged with a heat dissipator for easily securing and locating an electronic component onto a heat dissipator, and providing a means for attaching the heat dissipator assembly on a printed circuit or wiring board in different orientations.

### BACKGROUND OF THE INVENTION

More than ever before, today's electronic products are reducing the size, weight and cost, increasing power and speed substantially. Therefore in electronic packaging design, more and more clips or clamps have been used to replace the fasteners, rivets and adhesives, etc. in attaching electronic components or devices onto a heat dissipator to reduce the size and weight of heat dissipator assemblies, improve the thermal performance and manufacturability and lower the cost to meet the trends.

Generally a spring clip is a piece of a part made of any materials with better spring property and having some unique features to effectively and easily clamp or clip an electronic component against the heat absorbing surface of a heat dissipater while engaging the corporative relation with the heat dissipator.

Typically, a heat dissipator with an electronic component clipped on by a clip has to be, finally, attached onto a printed circuit or wiring board to be functioning electrically. Traditional means for attaching a heat dissipator assembly onto a printed circuit or wiring board mostly uses screws, rivets or solder tabs. This will add costs due to extra parts, more manufacturing work and time-consuming assembly operation.

Conventionally, a heat dissiaptor assembly with an electronic component clipped on is attached or assembled or mounted onto a printed circuit or wiring board in a certain orientation, for instance, vertical or horizontal to fit the space and cooling requirement, such as conduction, free or force convection cooling. The orientation is fixed as long as the heat dissipator design released. To make a change in orientation of a heat dissipator assembly, such as from vertical to horizontal, will cost a lot in engineering, documentations and drawings revising. Particularly after the product release, it will cost a fortune to make such a change.

For all these reasons, more and more spring clips have been suggested of being constructed as a multi-functional and universally mountable integral device which can not only secure and press an electronic component on a heat dissipator to eliminate mechanical fasteners, but also provide the means for attaching a heat dissipator assembly onto a printed circuit or wiring board to eliminate mechanical attachments, and further with the flexibility in mounting orientation change without incurring high cost. However, each of these spring clips is encumbered by one or another disadvantage which makes it less than ideal for its intended purpose. For example, the spring clips used in heat sink apparatus illustrated and described in U.S. Pat. Nos. 5,138,524; 5,068,764; 6,079,486; 6,075,703; 5,373,099 and 5,896,270 each of them uses a resiliently clip or clamp to attach the electronic device onto the heat dissipating body. But, none of these spring clips provides means for attaching the heat dissipator assembly onto a printed wire or circuit board.

U.S. Pat. No. 7,021,365 shows a spring clip apparatus for holding one or more electronic devices against the heat receiving side. However, the spring clip apparatus doesn't provide the element for attaching heat sink apparatus onto a printed wire or circuit board. The attachments still have to be accomplished by the means of tabs screwed in tapped holes in the heat sink apparatus which involves a time-consuming assembly operation and higher manufacturing cost.

U.S. Pat. No. 4,509,839 and 6,262,893 show an integral clip which resiliently grips the semiconductor and provides the means for attaching the heat dissipator to a printed circuit or wiring board. However, none of two integral clips provides the means of universal orientations for attaching the sink apparatus onto a printed wire or circuit board. The heat dissipator assembly can only be attached onto a print circuit or wiring board vertically.

Accordingly, what is needed is in the art of a multi-functional, universally mountable, simple design and lower cost integral spring clip which can be used with a heat dissipator or a heat sink apparatus to implement the resilient component or device clipping, automatic component locating and universal mounting mechanism with a heat dissipator so as to drive all the associated costs, such as extra parts, more manufacturing work, time-consuming assembly operations and engineering changes, down.

### SUMMARY OF THE INVENTION

An integral spring clip for use with a heat dissipator or heat sink apparatus comprises a securing portion and an attaching portion. The securing portion is configured to flex about a pivot axis to effect an engaged relation to substantially fixedly maintain the electronic component in abutting relation to the heat absorbing surface of a heat dissipater or a heat sink apparatus and secure it in a predefined position. The attaching portion comprises a plurality of solderable elements and is configured to attach a heat dissipator assembly in either vertical or horizontal orientation firmly onto a printed circuit or wiring board in a pre-defined place via soldering techniques. The ramified integral spring clip with a cam bar added on will further facilitate the assembly and disassembly operations. The integral spring clip is a simple unitary design and made of a single length spring wire with whole or selective solder coating.

The integral spring clip for use with a heat dissipator according to the present invention avoids the necessity for additional parts such as screws, nuts, washers or adhesives for securing an electronic component on the heat absorbing surface of a heat dissipator with sufficient force. The integral spring clip of the present invention also avoids fixturing in the time-consuming process of assembling an electronic component in the predefined position on the heat absorbing surface.

The integral spring clip for use with a heat dissipator according to the present invention avoids the necessity for using additional parts such as screws, nuts, rivets or tabs to attach a heat dissipator assembly onto a printed circuit or wiring board. The integral spring clip for use with a heat dissipator according to the present invention also eliminates the restriction of flexible mounting orientations for a heat dissipator assembly attached to a printed circuit or wiring board.

It is the object of the present invention to provide an integral spring clip of being unitarily constructed and made of a single length, inexpensive spring wire with inexpensive manufacturing process.

The foregoing has outlined, rather broadly, preferred and alternative features of the present invention so that those skilled in the art may better understand the detailed descriptions of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scopes of the invention in its broadest form.

### BRIEF DESCRIPTIONS OF THE DRAWINGS

FIG. 1 is a perspective drawing of an embodiment of the present invention.

FIGS. 2A, 2B and 2C are perspective and plain drawings showing how an embodiment of the present invention engages with a heat dissipator and an electronic component.

FIGS. 3A, 3B, 4A and 4B are the perspective and plain drawings of an embodiment of the present invention in use with different style heat dissipators.

FIGS. 5A and 5B are the plain views of an embodiment of the present invention in an assembly with a heat dissipator and an electronic component being attached to a printed circuit or wiring board in different orientations: vertical or horizontal.

FIG. 6 is the perspective view of the present invention's ramification with a cam bar added on for further facilitating assembling and disassembling an electronic component.

FIGS. 7A, 7B and 7C are the perspective drawings illustrating how the ramified embodiment of the present invention works with a heat dissipator in clipping an electronic component on.

### DETAILED DESCRIPTIONS OF THE INVENTION

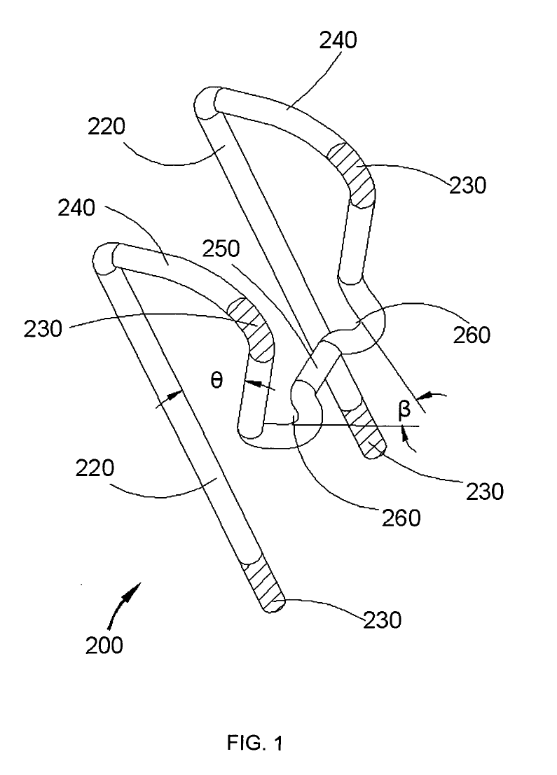

FIG. 1 is a perspective view of an integral spring clip 200 constructed according to a preferred embodiment of the present invention. Integral spring clip 200 can be manufactured from a single length of flat or round spring wire material, preferably round wire for ease of manufacturing and assembly, and is configured to be “η” shape-like, having a pair of straight legs 220, a pair of parallel curved arms 240 whose ends intersected with the pair of legs 220 and the other ends bridged by a clamping beam 250. The curved arms 240 comprise two segments: one is perpendicular to leg 220 and the other has an angle “θ” with, instead of parallel to, leg 220 for effective clipping action and sufficient clipping forces. Those skilled in the art will know the relationship between the clipping force and the degrees of the angle “0”. The two straight segments intersect each other with a large fillet. The curvature areas of the curved arms 240 and the free ends of the straight legs 220 are defined as the attaching portion 230 (hatched areas) for being attached to a printed circuit or wiring board via soldering. The connections between clamping beam 250 and a pair of curved arms 240 are formed in such a way so that the formed features have the auto-center mechanism with a pair of conical shapes. The pair of conical shaped features rised up above the clamping beam 250 to create a pair of tooling receptacle 260 for tool access to facilitate assembly operations. The angle β for the pair conical should be greater than 0° and smaller than 90° (0°<β<90°), preferably between 30° and 60°.

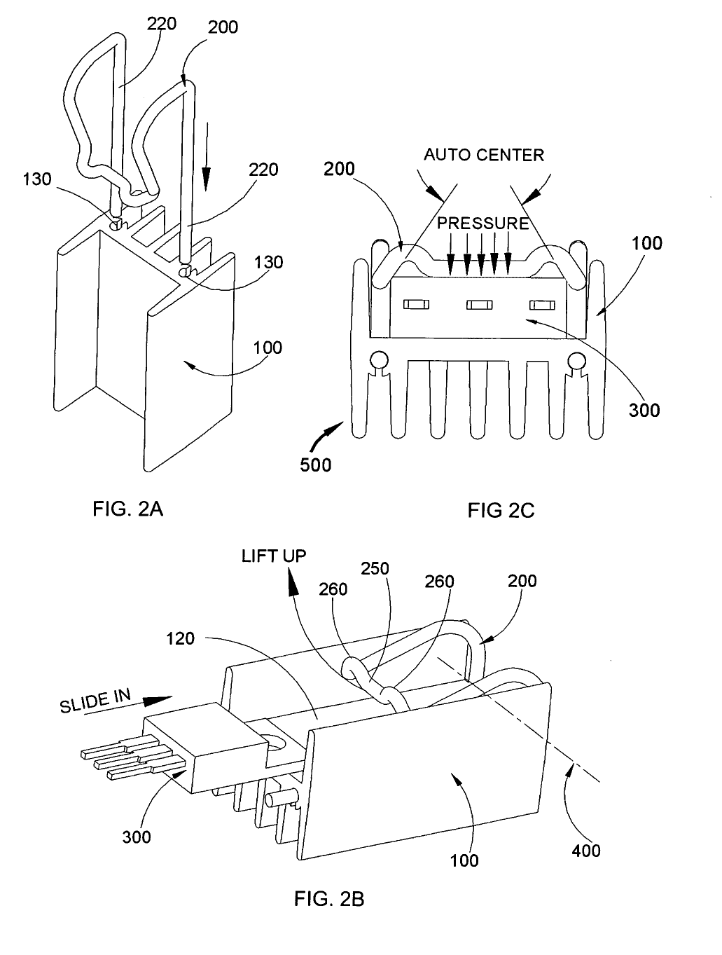

FIGS. 2A, 2B and 2C are perspective and plain drawings showing how an embodiment of the present invention engages with a heat dissipater and an component, and how its auto-center mechanism works. FIG. 2A shows the straight legs 220 of the spring clip 200 is inserting into the receiving apertures 130 of the heat dissipator 100. FIG. 2B shows that the spring clip 200 in fully engaged with heat dissipator 100 and therefore the pivot axis 400 is defined as the line going through the points initiating the constraints or confines between spring clip 200 and heat dissipater 100. The clamping beam 250 is flexing up with clipping arms 240 about pivot axis 400 while an electronic component 300 is sliding in. FIG. 2C shows that clamping beam 250 press on electronic component 300 resiliently against heat dissipator 100 with the force from the clipping arms while the conical feature on the integral spring clip 200 automatically center or locate the electronic component 300 in place.

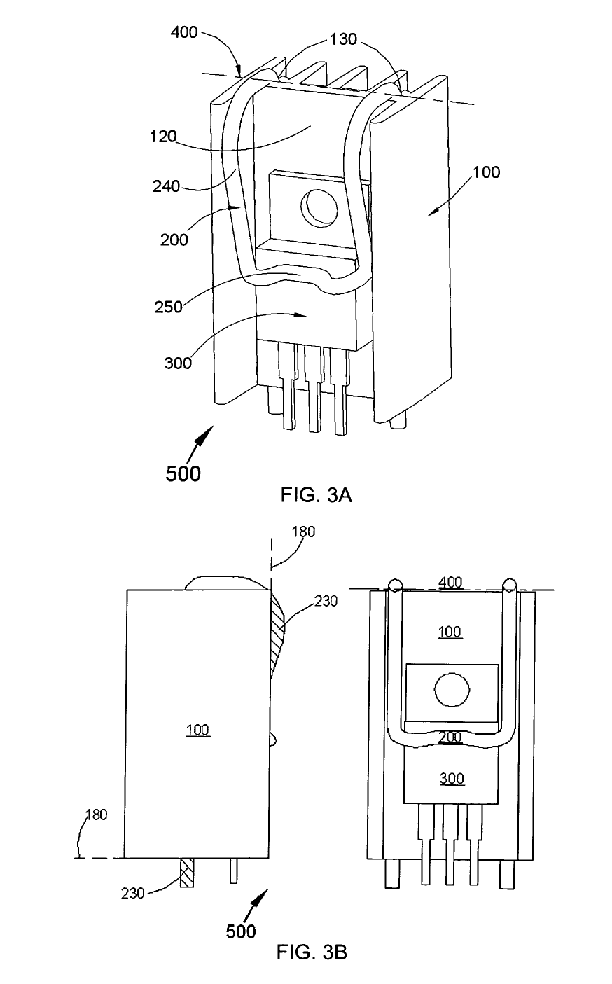

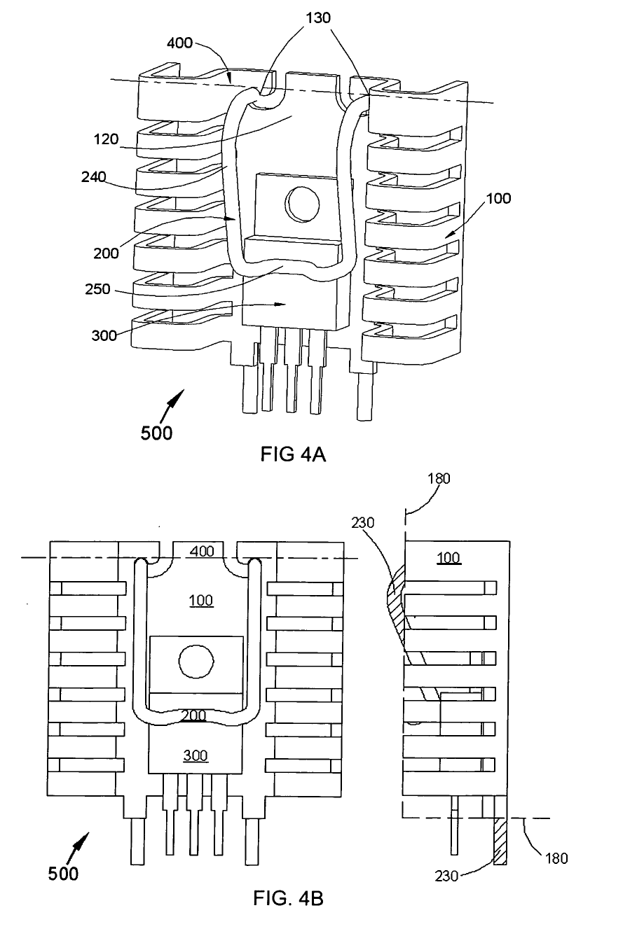

FIGS. 3A, 3B, 4A and 4B are perspective and plain drawings of an embodiment of the present invention in use with different styles heat dissipators. As seen in these figures, a heat dissipater assembly 500 consists of a heat dissipater 100, an integral spring clip 200 and an electronic component 300. Integral spring clip 200 engages within the receiving apertures 130 of the heat dissipators 100 and is confined by the apertures 130. The line going through the points initiating the constraints between spring clip 200 and heat dissipater 100 is defined as the pivot axis 400. Clipping arms 240 is flexing about the pivot axis 400 and making clamping beam 250 push the electronic component 300 resiliently against the heat absorbing surface 120 of the heat dissipater 100 to effect the heat transfer from the electronic component 300 to the heat dissipator 100. Heat dissipator boundary is defined as the outmost edges of the heat dissipator 100. The boundary lines 180 are co-linear with these edges. At least one element of attaching portion 230 of the integral spring clip 200 is protruded outside the boundary line 180 of the heat dissipator 100 for being used to attach the assembly 500 onto a printed circuit or wiring board (not shown here).

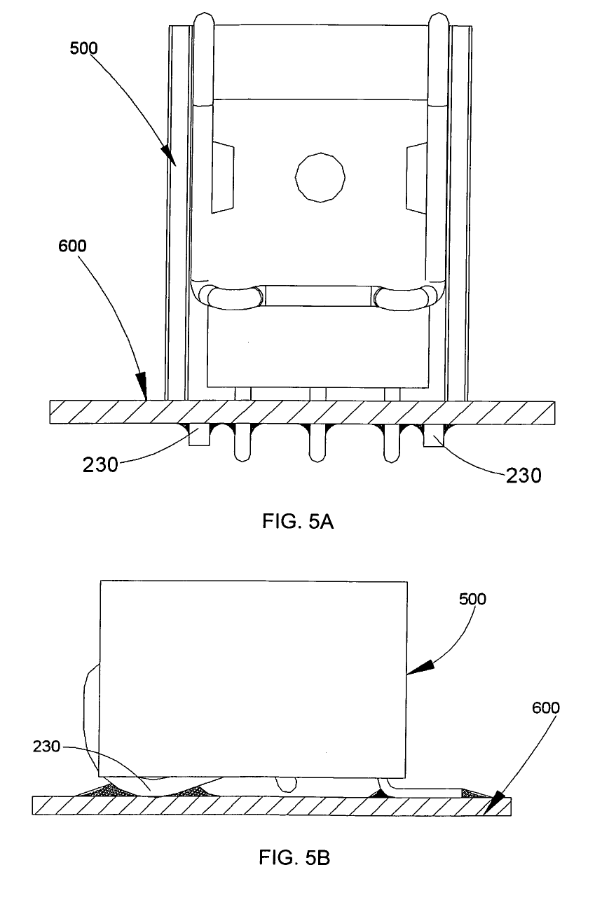

FIGS. 5A and 5B are the plain views of an embodiment of the present invention in an assembly with a heat dissipators and an electronic component being attached to a printed circuit or wiring board vertically or horizontally. FIG. 5A shows that a heat dissipator assembly 500 with present invention is vertically orientated and attached to a printed circuit or wiring board 600 by the attaching portion 230 via through-hole soldering, while FIG. 5B shows that a heat dissipator assembly 500 with present invention is horizontally oriented and attached to a printed circuit or wiring board 600 by the attaching portion 230 via surface-mounting soldering. Apparently, this universal mountable heat dissipator or heat sink apparatus gives the maximum flexibilities for printed circuit or wiring broad layouts, circuit designs, cooling technologies selecting and managing space constraints.

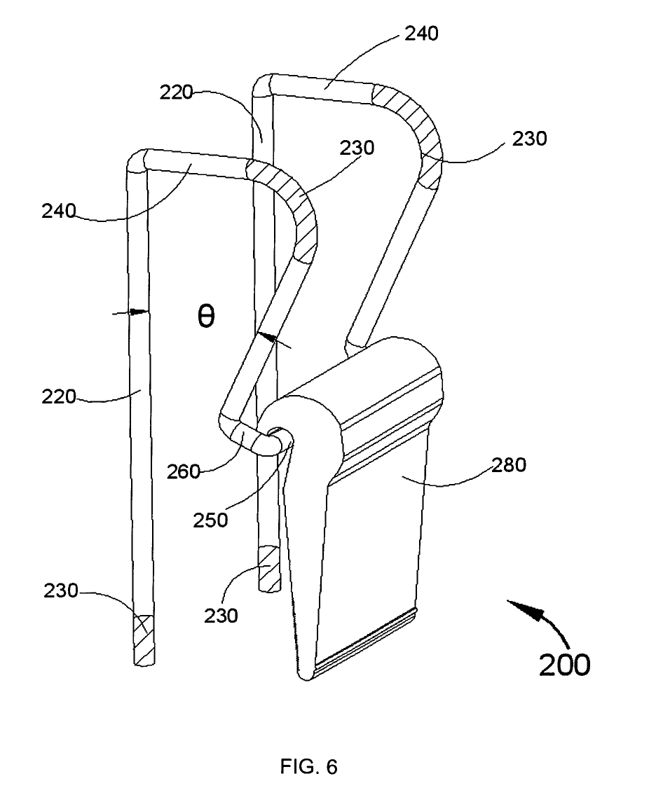

FIG. 6 is the perspective view of the present invention's ramification with a cam bar added on for further facilitating the operation in assembling and disassembling an electronic component. As shown in this figure, the original pair conical rise-ups is replaced by a pair of straight rise-ups 260 which will be used to prevent the electronic component moving sideway and lock it in place. A cam bar 280 is mated with clamping beam 250 co-axially. Now the clamping beam 250 is functioning as a bearing for the cam bar 280 to rotate about. The rotation angle for cam bar 280 is at least 180°.

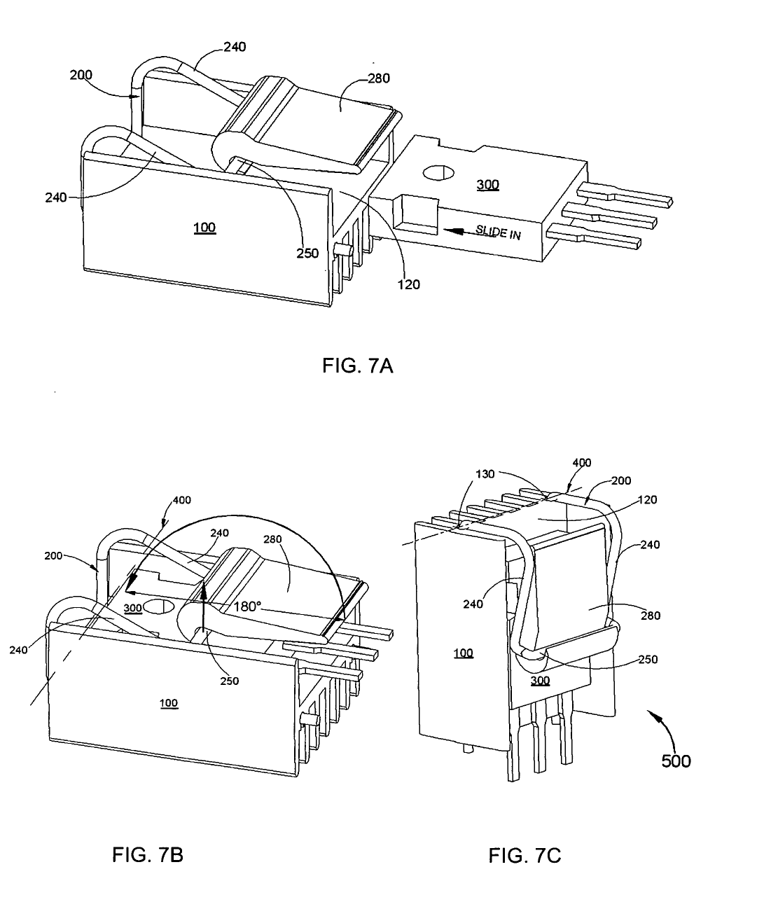

FIGS. 7A, 7B and 7C are the perspective drawings illustrating how an ramified embodiment of the present invention works with a heat dissipator in clipping an electronic component on. As shown in FIG. 7A, cam bar 280 is at the smallest radius of the eccentric position and parallel to heat absorbing surface 120. An electronic component 300 is sliding in and making contact with the heat absorbing surface 120. When rotating the cam bar 280, the rise of the cam gradually lifts the eccentric axis—clamping beam 250 until reaching the largest radius of the eccentric position at 1800 rotation angle where the flat portion of the cam bar 280 presses component 300 against heat dissipator 100 firmly leveraged by the clipping arms 240. FIG. 7B shows that the electronic component 300 is in the place and confirmed by the straight rise-up 260 sideway. FIG. 7C shows the finished assembled unit of a heat dissipator 100 and an electronic component 300 with the ramified integral spring clip 200.

Although only a few embodiments of the present invention have been described, it should be understood that the present invention be embodied in many other specific forms without departing from the spirit or the scope of the present invention. The present examples are to be considered as illustrative and not restrictive, and the invention is not to be limited to the details given herein, but may be modified within the scope of the appended claims along with their full scope of equivalents.

I claim:

1. An integral spring clip for use with a heat dissipator to secure an electronic component firmly against a heat absorbing surface of a heat dissipator, and attach the heat dissipator assembly onto a printed circuit or wiring board in universal orientations, comprising:
(a) a securing portion; and
(b) an attaching portion;
said securing portion has at least one straight leg configured to be mated within a receiving aperture of the heat dissipator and being confined within, and at least one curved clipping arm configured to flex about one pivot axis resiliently to effect an engaged relation with said heat dissipator; said integral spring clip and said heat dissipator cooperating in said engaged relation to substantially fixedly maintain said electronic component in abutting relation with said heat dissipator; said attaching portion configured to attach a heat dissipator to a printed circuit or wiring board.

2. An integral spring clip for use with a heat dissipator as recited in claim 1 wherein said attaching portion comprising a plurality of solderable elements;

3. An integral spring clip for use with a heat dissipator as recited in claim 2 wherein said solderable elements defined as the free end of said straight leg and curvature area of said curved clipping arm.

4. An integral spring clip for use with a heat dissipator as recited in claim 2 wherein at least one said solderable element of said attaching portion is protruded outside said heat dissipater boundary;

5. An integral spring clip for use with a heat dissipator as recited in claim 1 wherein said integral spring clip configured to be “η” shape-like comprising a pair of parallel straight legs, and a pair of parallel curved arms bridged by a clamping beam.

6. An integral spring clip for use with a heat dissipator as recited in claim 5 wherein said curved clipping arms comprising two segments intersected with large fillet.

7. An integral spring clip for use with a heat dissipator as recited in claim 6 wherein one of said two segments of said curved clipping arms intersects with said leg perpendicularly while the other having an angle “θ” with said leg for effective clipping force when flexing about said pivot axis;

8. An integral spring clip for use with a heat dissipator as recited in claim 5 wherein said clamping beam configured to have the auto-center mechanism with a pair of conical shaped tooling receptacles rising up above the center portion of said clamping beam to facilitate component assembly at the intersections with said curved clipping arms.

9. An integral spring clip for use with a heat dissipator as recited in claim 8 wherein said conical shape having the angle β which should be greater than 0° and smaller than 90° (0°<β<90°), preferably between 30° and 60°;

10. An integral spring clip for use with a heat dissipator as recited in claim 5 wherein said claming beam in contact with said component directly and press it against said heat dissipator leveraged by said clipping arms.

11. An integral spring clip for use with a heat dissipator as recited in claim 1 wherein said integral spring clip may be fabricated with a single length spring wire, flat or round shape with whole or selective solder coating.

12. An integral spring clip for use with a heat dissipator as recited in claim 1 wherein said integral spring clip may be added with a cam bar to further facilitate the assembly and disassembly operations.

13. An integral spring clip for use with a heat dissipator as recited in claim 12 wherein said cam bar mated with said clamping beam co-axially;

14. An integral spring clip for use with a heat dissipator as recited in claim 13 wherein said cam bar can be rotated about said clamping beam at least 180°;

15. An integral spring clip for use with a heat dissipator as recited in claim 1 wherein said one pivot axis is defined by the line going through the points initiating the constraints between said legs of said spring clip and said receiving apertures of said heat dissipater.

16. An integral spring clip for use with a heat dissipator as recited in claim 1 wherein said receiving apertures of said heat dissipater can be slots or holes or any other features which must be fitted with said legs of said integral spring wire to effect the constraint for clipping mechanism.

17. An integral spring clip for use with a heat dissipator to secure an electronic component firmly against a heat absorbing surface, and attach the whole heat dissipator assembly onto a printed circuit or wiring board universal orientations, comprising:
(a) a securing portion;
(b) an attaching portion; and
(c) a means for universal orientation attachment;
said securing portion comprises at least one straight leg configured to be mated with a receiving aperture of said heat dissipator and being confined within, at least one curved clipping arm configured to flex about one pivot axis resiliently to effect an engaged relation with said heat dissipator and at least one clamping beam pressing directly on said component; said integral spring clip and said heat dissipator cooperating in said engaged relation to substantially fixedly maintain said electronic component in abutting relation with said heat dissipator; said attaching portion configured to be soldered to a printed circuit or wiring board; said means for universal orientation attachment configured to attach a heat dissipator to a printed circuit or wiring board either horizontally or vertically.

18. An integral spring clip for use with a heat dissipator as recited in claim 17 wherein said means for universally orientated attachment is to attach said heat dissipater assembly to said printed circuit or wiring board via either though-hole mounting or surface mounting;

19. An integral spring clip for use with a heat dissipator as recited in claim 18 wherein said means for universally orientated attachment is an option of utilizing different elements of said attaching portion.
